(19) United States
(12) Patent Application Publication
(10) Pub. No.: US 2007/0196762 A1
(43) Pub. Date: Aug. 23, 2007

(54) Scuff plate

(75) Inventors: Hideto Maeda, Aichi-ken (JP); Daiichiro Kawashima, Aichi-ken (JP); Tatsuya Oba, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/707,962

(22) Filed: Feb. 20, 2007

(30) Foreign Application Priority Data
Feb. 20, 2006 (JP) 2006-043039

(51) Int. Cl. G03C 8/00

(52) U.S. Cl. 430/211

(57) ABSTRACT

To provide a scuff plate that produces no irregularity in illumination or light emission, a scuff plate 1 of the invention has a light emitting element 2 which has a pillar-like shape and of which a portion which makes up at least part of an outer circumferential side and extends in an axial direction makes up a light emitting surface 20, a light reflecting element 6 which reflects light emitted from the light emitting element 2, and a light guiding element 3 which has a plate-like shape which transmits light and which is disposed in a position where a rear surface 3b thereof becomes opposite to the light reflecting element 6 and light reflected by the light reflecting element 6 is shone on thereto, wherein a space is provided between the rear surface 3b of the light guiding element 3 and the light reflecting element 6.

### BACKGROUND OF THE INVENTION

1. Field of the Invention

The present invention relates to a scuff plate and more particularly to a scuff plate which provides a superior external appearance not only when it is lit up at night or the like but also when it is not lit up during the daytime or the like.

2. Description of the Related Art

In recent years, a scuff plate is mounted on an edge portion of a door opening of a vehicle to protect a side sill portion. In addition, with a scuff plate in which a designed pattern of characters or the like is illuminated, a decorative effect is obtained.

An illuminated scuff plate includes, for example, a light guiding plate on which irregularities are formed and a light emitting element for shining light which is provided on a side surface of the light guiding plate and has a construction in which light is shone to the side surface of the light guiding plate for illumination. Scuff plates like this are disclosed in, for example, JP-A-2002-108257 and JP-A-2003-237458.

JP-A-2002-108257 describes an illumination apparatus which is made up of an LED light source, a light guiding plate on a rear surface of which a character portion made up of desirably shaped recessed or raised portions is formed, and a sheet of which a circumferential edge portion is bonded to the light guiding plate.

JP-A-2003-237458 describes a scuff plate illumination apparatus which is made up of a display plate having a display portion made up of recessed or raised portions and a light source device disposed close to the display plate and adapted to shine light on to the display portion from a side or obliquely a top thereof.

In these scuff plates that are configured as has been described above, however, since light is shone to the light guiding plate from the side thereof to illuminate the light guiding plate, there has been caused a problem that light traveling through the light guiding plate is totally reflected on a surface of the light guiding plate and the light so reflected escapes from a direction of an opposite side surface of the light guiding plate to the side thereof to which light is shone. Namely, there has been caused a problem that only part (the direction of the opposite side) of the light guiding plate is illuminated and hence the designed portion where the irregularities are formed is not sufficiently illuminated.

### SUMMARY OF THE INVENTION

The invention was made in view of the situations described above, and a problem that the invention is to solve is to provide a scuff plate which produces no irregularity in illumination or light emission.

The invention was made as a result of studies made repeatedly on scuff plates with a view to solving the problem.

Namely, according to the invention, there is provided a scuff plate having a light emitting element which has a pillar-like shape and of which a portion which makes up at least part of an outer circumferential side and extends in an axial direction makes up a light emitting surface, a light reflecting element which reflects light emitted from the light emitting element, and a light guiding element which has a plate-like shape which transmits light and which is disposed in a position where a rear surface thereof becomes opposite to the light reflecting element and light reflected by the light reflecting element is shone on thereto, wherein a space is provided between the rear surface of the light guiding element and the light reflecting element.

In the scuff plate of the invention, since the space is defined between the light guiding element and the light reflecting element, reflection of light is repeated between the rear surface of the light guiding element and the light reflecting element. Light is diffused within the space because of the repetition of reflection of light. Because of the diffuse reflection, light which is transmitted through the light guiding element is directed in various directions and hence is transmitted through a wide area of the light guiding element, whereby a wide area on the surface of the light guiding element is allowed to be illuminated. Namely, the scuff plate results which has no irregularity in illumination or light emission.

In addition, in the scuff plate of the invention, since the space is defined between the light guiding element and the light reflecting element, an advantage is exhibited that the external appearance of the scuff plate when it is not illuminated is enhanced.

### BRIEF DESCRIPTION OF THE DRAWINGS

FIG. 1 is an exploded view of a scuff plate of Embodiment 1.

FIG. 2 is a sectional view of the scuff plate of Embodiment 1.

FIG. 3 is a sectional view of a scuff plate of Embodiment 2.

### DESCRIPTION OF THE PREFERRED EMBODIMENTS

A scuff plate of the invention has a light emitting element, a light reflecting element and a light guiding element.

The light emitting element is a member which has a pillar-like shape and of which a portion which makes up at least part of an outer circumferential side and extends in an axial direction makes up a light emitting surface. Namely, in the scuff plate of the invention, the light emitting surface of the light emitting element which extends in the axial direction thereof is illuminated to emit light over a surface thereof. Here, the light emitting surface may be made up of a flat surface or a curved surface.

The light reflecting element reflects light emitted from the light emitting element. Light reflected by the light reflecting element is shone on to the rear surface of the light guiding element. There is no specific limitation on the light reflecting element with respect to a material therefor and a configuration thereof, provided that the light reflecting element is made up of a member which can reflect light, and hence, the light reflecting element may be made up of a metallic plate or a member in which a metal-plated layer is formed on a surface thereof. In addition, an irregular pattern may be or may not be formed on a reflecting surface of the light reflecting element.

The light guiding element is a member which has a plate-like shape which transmits light and is located in a position where a rear surface thereof becomes opposite to the light reflecting element and light reflected by the light reflecting element is shone on thereto. Namely, light reflected by the light reflecting element is shone on to the rear surface of the light guiding element. In addition, since the light guiding element is formed in such a manner as to transmit light, light shone on to the rear surface is transmitted through the light guiding element to thereby be emitted from a surface thereof, whereby the scuff plate of the invention is illuminated.

In addition, in the scuff plate of the invention, a space is provided between the rear surface of the light guiding element and the light reflecting element. By having the space between the rear surface of the light guiding element and the light reflecting element, light emitted form the light emitting surface of the light emitting element is reflected on the light reflecting element and is thereafter shone on to the rear surface of the light guiding element. Part of the light shone on to the rear surface of the light guiding element is reflected on the rear surface so as to be shone back on to the light reflecting element. Namely, diffuse reflection is produced within the space. The traveling direction of light is directed into various direction within the interior of the space because of the diffuse reflection, and light directed in the various direction is transmitted through the light guiding element. Since light passing through the light guiding element is caused to travel in the various directions, light that has been transmitted through the light guiding element is emitted from a wide area of the surface of the light guiding element. Namely, the wide area on the surface of the light emitting element is illuminated. In addition, since the light directed in the various direction is emitted from the wide area of the surface of the light guiding element, the scuff plate results which has no irregularity in illumination or light emission.

Furthermore, in the scuff plate of the invention, since the space is defined between the light guiding element and the light reflecting element, even when the scuff plate is not lit, light entering the light guiding element from the surface thereof diffuses within the space. Namely, the external appearance of the scuff plate is enhanced in such a state that the light emitting surface emits no light in the daytime or the like (when the scuff plate is not lit).

In the scuff plate of the invention, there is no specific limitation on the configuration of the space so formed, provided the space is configured so as to produce diffuse reflection.

The space is preferably formed into a tapered shape in which a distance between the rear surface of the light guiding element and the light reflecting element becomes shorter as the space extends from one end portion to the other end portion of the light guiding element. Since the space is formed into the tapered shape, light emitted by the light emitting element which lies at the one end portion of the light guiding element produces diffuse reflection on an interface lying on a rear surface side of the light guiding element to thereby be shone on to the light reflecting element. Namely, due to the diffuse reflection being produced on the interface lying on the rear surface side of the light guiding element, of light emitted from the light emitting element, light traveling from one end portion to the other end portion of the light guiding element is prevented from being transmitted through the light guiding element as originally intended.

The tapered shape of the space may be formed by either inclining the rear surface of the light guiding element or inclining the surface (the light reflecting surface) of the light reflecting element. In addition, both the surfaces may be inclined to form the tapered shape. The rear surface of the light guiding element is preferably inclined. Here, the inclination of the rear surface of the light guiding element is an inclination of part of the rear surface relative to the direction of light emitted from the light emitting surface. By this configuration, an inclined surface reflects light, and light so reflected diffuses within the interior of the space.

A rib which projects towards a direction of the light reflecting element is preferably formed on the rear surface of the light guiding element in the vicinity of the one end portion thereof. Namely, an inclined space can be formed between the rear surface of the light guiding element and the light reflecting element by the rib so formed. In addition, by having the rib, the rigidity of the member making up the light guiding element is increased.

A secondary rib is preferably formed on the rear surface of the light guiding element in the vicinity of the other end portion thereof which secondary rib has a projecting height which is shorter than the rib formed in the vicinity of the one end portion of the light guiding element. By having the secondary rib, the scuff plate can be held in such a state that the rear surface of the light guiding element is inclined, and the rigidity of the member making up the light guiding element is increased.

The scuff plate of the invention preferably has a recessed portion which is recessed into a concave shape on the rear surface of the light guiding element. In addition, side wall surfaces of the recessed portion preferably expand in a direction which intersects a front surface (or the rear surface) of the light guiding direction, whereby when light is shone on to the tight guiding element, the side wall surfaces of the recessed portion make up light emitting surface portions. Due to the side wall surfaces of the recessed portion making up the light emitting surface portions, the light emitting surface portions are illuminated by virtue of a difference in refractive index between a material making up the light guiding element and air. Here, the recessed portion preferably has a desired designed shape.

There is no specific limitation on the sectional shape of the recessed portion. Namely, any sectional shape may be adopted, provided that a sectional shape adopted can form side wall surfaces which make up light emitting surface portions. Here, the width of the side wall surfaces (a depth from the front surface) is preferably larger. Namely, the deeper the depth of the recessed portion gets, the more light that is transmitted through the light guiding element is transmitted through the light emitting surface portions, and the amount of light that travels in the direction of the front surface of the planar light emitting element, whereby the light emitting effect of the planar light emitting element is increased. Note that the recessed portion may or may not have a bottom surface portion, provided that the recessed portion has a sectional shape which provides side wall surfaces which make up light emitting surface portions. In addition, the side wall surface does not necessarily have to have a shape which is formed by straight lines. Namely, the side wall surface may be curved. That is the sectional shape of the recessed portion may be formed into any of the concave shape, a U-shape and a V-shape.

The side wall surfaces of the recessed portion may only have to expand in the direction which intersects the front surface (or the rear surface) of the light guiding element, and there is no specific limitation on an angle that is formed by the expanding surfaces and the front surface of the light guiding element. An angle ranging from 30 to 45° is preferably formed between the expanding surfaces making up the light emitting surface portions and the surface of the light guiding element.

There is no limitation on the configuration and material of the light emitting element, provided that a light emitting surface of a member used therefor can emit light. For example, a light emitting element can be made up of a substantially pillar-shaped member which is formed by dispersing a diffuser made of a material which reflects light in a light transmitting resin such as an acrylic resin and a polycarbonate and a light shining device such as an LED and an electric lamp which shines light on to an axial end face of the substantially pillar-shaped member. Alternatively, a light emitting element can be made up of a substantially prism-shaped member which is formed of a light transmitting resin such as an acrylic resin and a polycarbonate and a light shining device such as an LED and an electric lamp which shines light on to an axial end face of the substantially prism-shaped member.

When the light emitting element is made up of the substantially pillar-shaped member which contains the diffuser and the light shining device such as an LED and an electric lamp which shines light on to the axial end face of the substantially pillar-shaped member, there is no specific limitation on the sectional shape of the substantially pillar-shaped member. Namely, the substantially pillar-shaped member may be formed into a circular cylindrical shape or a prism shape. In addition, as the diffuser which is dispersed in the substantially pillar-shaped member, any material can be used, provided that the material used is dispersed in such a manner as to alter the traveling direction of light which is transmitted through the substantially pillar-shaped member in an axial direction thereof into a radial direction, and for example, calcium carbonate, titanium oxide and barium sulfate can be raised.

When the light emitting element is made up of the substantially prism-shaped member and the light shining device such as an LED and an electric lamp which shines light on to the axial end face of the substantially prism-shaped member, it is preferable that the substantially prism-shaped member has an opposite surface which is opposite to the light emitting surface and that a diffusing treatment is applied to the opposite surface which alters the traveling direction of light. With the diffusing treatment applied to the opposite surface, light shone on to the axial end face of the substantially prism-shaped member is made to travel in a direction of the light emitting surface. There is no specific limitation on the type of diffusing treatment, and for example, there can be raised a method in which a printing treatment such as a white silk-screen printing and a gradation dot printing is applied to the opposite surface of the substantially prism-shaped member and a method in which a gradation pattern or groove is formed on the opposite surface. When used herein, the gradation dot printing and gradation pattern denote a treatment process in which a dot printing or embossing process is applied in such a manner that the amount of diffusing treatment differs in accordance with a distance from the light shining device (in such a manner that the longer the distance from the light shining devices gets, the higher the light diffusion amount increases).

The scuff plate preferably has a cover which is disposed on the front surface of the light guiding element so as to cover at least the light emitting element and a light source element. By covering at least the light emitting element and the light source element, the light emitting element and the light source element are prevented from being exposed, and light emission from the other elements than the light guiding element cannot be visualized, whereby the external appearance of the scuff plate is enhanced. In addition, by having the cover, even though the scuff plate is scuffed by the shoe or shoes when the drive or other occupant of the vehicle gets in or out of the vehicle, the failure of the scuff plate is prevented.

In the scuff plate of the invention, a substance having a refractive index which differs from that of the light guiding element may be filled within the space defined between the rear surface of the light guiding element and the light reflecting element. By disposing the substance light this in the space, the refractive index in the space is changed, so as to adjust light that is to be shone on to the light guiding element. As the substance like this, gas such as air or liquid such as oil can be raised.

### Embodiments

Hereinafter, the invention will be described by reference to embodiments.

A scuff plate was produced as an example of the invention.

### Embodiment 1

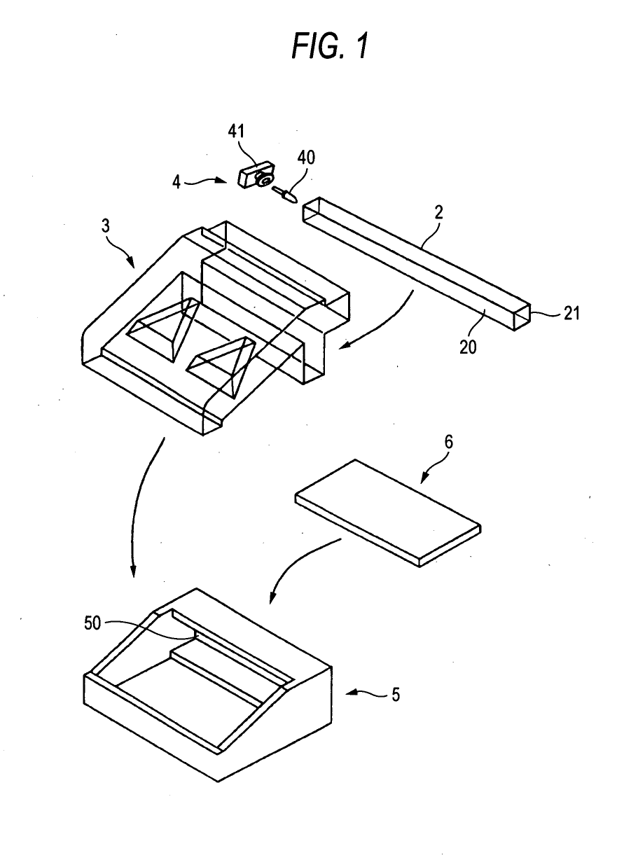

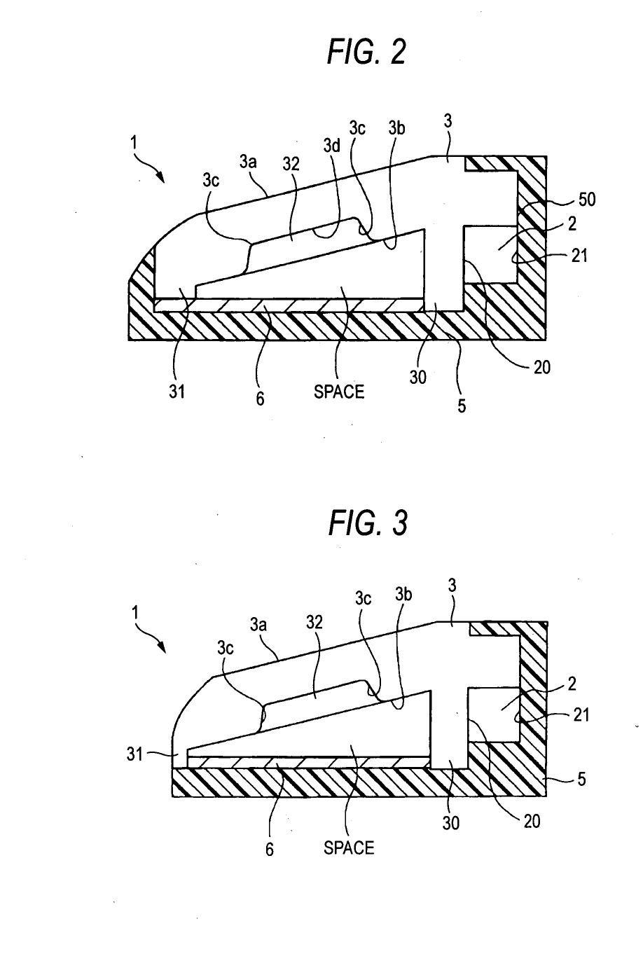

A scuff plate of this embodiment is shown in an exploded view in FIG. 1 and in a cross-sectional view in FIG. 2. Note that FIG. 2 is a cross-sectional view showing a cross section taken at a substantially central portion of a light guiding plate 3.

A scuff plate 1 of this embodiment has a light emitting member 2, a light guiding plate 3, a light source element 4, a scuff plate main body 5, and a reflecting plate 6.

The light emitting member 2 is a prism-shaped transparent member which is made of an acrylic resin and which has a square cross section. A side surface of the prism which makes up the light emitting member 2 constitutes a light emitting surface 20. In addition, an embossing treatment is applied to a whole surface of a side surface 21 which is opposite to the light emitting surface 20 to thereby form an embossed pattern thereon. The embossed pattern is formed in such a manner as to become smaller as it expands axially from one end to the other end of the side surface 21.

The light guiding plat 3 is made up of a transparent belt-shaped acrylic plate whose length substantially coincides with the length of the light emitting member 2. A support rib 30 is provided to project from a position on a rear surface 3b of the light guiding plate 3 which lies width ways inwards a distance larger than a width of the light emitting member 2 from one end portion in a width direction of the rear surface 3b in such a manner as to extend in an inclined direction relative to the rear surface 3b In addition, a support rib 31 is provided to project from a position on the rear surface 3b which lies at the other end portion in the width direction of the rear surface 3b in such a manner as to extend in an inclined direction relative to the rear surface 3b. The light guiding plate 3 is disposed in such a state that the light guiding plate 3 is inclined in the width direction thereof by these two ribs 30, 31.

In addition, the light guiding plate 3 has a recessed portion 32 on the rear surface 3b thereof. The recessed portion 32 has a shape which is recessed from the rear surface 3b and is formed into a predetermined designed shape. In this embodiment, the recessed portion is formed into a “ΔΔ” shape. Side wall surfaces 3c which define the recessed portion 32 are formed in such a state that the side wall surfaces 3c are inclined relative to a front surface 3a of the light guiding plate 3. In addition, a bottom surface 3d which defines the recessed portion 32 is formed parallel to the front surface 3a.

The light emitting member 2 is disposed on the rear surface 3b of the light guiding plate 3 width ways closer to the one end portion than the rib 30 is in such a state that a side surface of the rib 30 faces the light emitting surface 20 of the light emitting member 2.

The light source element 4 includes a light emitting diode 40 which is assembled on to a circuit board 41. The light emitting diode is disposed in such a state that the diode faces an axial end face of the light emitting member 2. The light emitting diode 40 is electrically connected to a power supply (not shown) that is provided outside of the scuff plate 1 and emits light by power from the power supply. Light emitted by the light emitting diode 40 is shone on to the axial end face of the light emitting member 2.

The reflecting plate 6 is disposed in such a state that the plate faces the rear surface 3b of the light guiding plate 3 and is spaced apart therefrom by the ribs 30, 31. The reflecting plate 6 is made of up of an aluminum plate. A space is defined between the reflecting plate 6 and the rear surface 3b of the light guiding plate 3 which corresponds to projecting heights of the ribs 30, 31.

The scuff plate main body 5 holds and fixes the light emitting member 2, the light guiding plate 3 and the light source element 4. The scuff plate main body 5 has a prism-like shape of a substantially triangular cross section and has therein a cut-out portion 50 for holding the light emitting member 2, the light guiding plate 3 and the light source element 4 in an interior thereof.

Hereinafter, a light emitting operation of the scuff plate 1 of the embodiment will be described.

Firstly, in the scuff plate 1 of the embodiment, when the light emitting diode 40 is energized, the light emitting diode 40 emits light. Light emitted by the light emitting diode 40 is shone on to the axial end face of the light emitting member 2. Light shone on to the light emitting member 2 then travels through an interior of the light emitting member 2 in the axial direction thereof.

Light which travels in the interior of the light emitting member 2 in the axial direction thereof so travels while diffusing in the interior of the light emitting member 2. The light then reaches the side surface 21. The embossing treatment is applied to the side surface 21, and a reflection of light is generated on the side surface 21, as an interface, on which the embossed pattern is formed. As this occurs, the traveling direction of light is bent by virtue of a difference in refractive index between the acrylic resin which makes up the light emitting member 2 and outside air and by the action of the side surface 21 on which the embossed pattern is formed, and light is then emitted from the light emitting surface 20.

In addition, the reflection amount of light on the side surface 21 on which the embossed pattern is formed increases as the embossed pattern becomes smaller. Namely, since the embossed pattern formed on the side surface 21 of the light emitting member 2 is formed to become smaller as it expands to increase the distance from the light emitting diode 40, the light emitting surface 20 can obtain a sufficient amount of light even at the other end portion thereof. In other words, the light emitting surface 20 is illuminated uniformly in the axial direction of the light emitting member 2.

Then, light emitted from the light emitting surface 20 of the light emitting member 2 is shone on to the side surface of the support rig 30 to thereby be transmitted through the support rib 30. Light (rays of light) that has passed through the support rib 30 produces diffuse reflection within the space defined between the rear surface 3b of the light guiding plate 3 and the reflecting plate 6 and then travels in various directions. To be specific, when light is reflected on the rear surface 3b of the light guiding plate 3, the light so reflected travels towards the reflecting plate 6, on which the light is reflected to travel towards the light guiding plate 3.

Light that is not reflected on the rear surface 3b of the light guiding plate 3 travels through the interior of the light guiding plate 3 to thereby be emitted to the outside from the front surface 3a of the light guiding plate 3. Here, since light traveling in various directions is transmitted through the light guiding plate 3 in a direction directed from the rear surface 3b towards the front surface 3a, the whole area of the front surface 3a of the light guiding plate 3 is illuminated so as to emit light therefrom. Namely, the light guiding plate 3 is illuminated without producing irregularity in illumination or light emission. In addition, since the light emitting surface 20 of the light emitting member 2 is illuminated uniformly, the scuff plate of this embodiment emits uniform light also in the axial direction of the light guiding plate 3.

Furthermore, light that has impinged upon the side wall surfaces 3c of the recessed portion 32 on the light guiding plate 3 is refracted on the side wall surfaces 3c to thereby be emitted from the front surface of the light guiding plate 3. Here, the side wall surfaces 3c are formed in such a manner as to produce a predetermined shape, and when viewed from the front surface thereof, the scuff plate 1 is visualized in such a state that the side wall surfaces 3c are illuminated more intensely, whereby the predetermined shape formed by the side wall surfaces 3c can be visualized as a three-dimensional design.

As has been described heretofore, the scuff plate of this embodiment results in a scuff plate whose external appearance is enhanced when it is lit up.

In addition, in the scuff plate 1 of this embodiment, even in such a state that the light emitting diode 40 is emitting no light, outside light such as sunlight or the like is transmitted through the light guiding plate 3 and is then reflected by the reflecting plate 6. As this occurs, diffuse reflection is produced between the rear surface 3b of the light guiding plate 3 and the reflecting plate 6, and light so reflected is transmitted through the light guiding plate 3 again so as to be visualized. Namely, in the scuff plate of this embodiment, a metallic gloss generated by the reflecting plate 6 is visualized when the light emitting diode 40 emits no light, whereby the external appearance of the scuff plate when it is not lit up is also enhanced.

In addition to this, the scuff plate 1 of this embodiment has the configuration in which the members which are necessary for illumination (the light emitting member 2, the light guiding plate 3, the light source element 4 and the reflecting plate 6) are accommodated in the scuff plate main body 5, whereby a compact construction is realized. Furthermore, since the light emitting member 2 is configured so as to apply light to the light guiding plate 3 which has the recessed portion 32 which exhibits the design, there is eliminated a direct relationship between the thickness of the light guiding plate 3 and the size of the light source element 4. Namely, even in the event that the size of the light source element 4 is increased, the thickness of the light guiding plate 3 does not necessarily have to be increased. In other words, with the scuff plate 1 of this embodiment, the movement of the feet of the driver or other occupant is not affected at all when the scuff plate is mounted on a vehicle, and moreover, a wide space can be secured on the rear side thereof for a wiring harness.

### Embodiment 2

This embodiment provides a similar scuff plate to that of Embodiment 1 above except that a light guiding plate 3 and a scuff plate main body 5 differ in shape from those of Embodiment 1. A cross-sectional view of the scuff plate of this embodiment is shown in FIG. 3.

In the scuff plate of this embodiment, the light guiding plate 3 is formed into a curved shape in which the other end portion in a width direction of the light guiding plate 3 is exposed. In addition, the scuff plate main body 5 holds the light guiding plate 3 in such a manner that the other end portion of the light guiding plate 3 is exposed.

Since the scuff plate of this embodiment has a space defined between a rear surface 3b of the light guiding plate 3 and a reflecting plate 6 for production of diffuse reflection, as with Embodiment 1 above, there is also exhibited an advantage that a front surface of the light guiding plate 3 is illuminated without producing any irregularity in illumination or light emission.

Furthermore, since the other end portion of the light guiding plate 3 is exposed, light is emitted from the other end portion of the light guiding plate 3. In addition, the scuff plate of this embodiment is assembled on to a side sill portion of a vehicle in such a state that an other end portion side of the light guiding plate 3 is directed towards the inside of a passenger compartment of the vehicle. When the scuff plate is illuminated in this state, light is emitted from the other end portion of the light guiding plate 3 in a direction in which the light guiding plate 3 expands, and light so emitted illuminates part of the passenger compartment where the feet of the driver or other occupant of the vehicle rest. Namely, the scuff plate of this embodiment functions not only as the scuff plate but also as floor illuminating equipment.

Also in the scuff plate of this embodiment, as with Embodiment 1, a similar compact construction is provided, the movement of the feet of the driver or other occupant is not affected at all when the scuff plate is mounted on a vehicle, and moreover, a wide space can be secured on the rear side thereof for a wiring harness.

### Other Embodiment

In the scuff plates of the individual embodiments that have been described heretofore, a light reflecting layer which can reflect light may be formed on a surface of the scuff plate main body 5 which is opposite to the light emitting member 2.

What is claimed is:

1. A scuff plate, having:
a light emitting element which has a pillar-like shape and of which a portion which makes up at least part of an outer circumferential side and extends in an axial direction makes up a light emitting surface;
a light reflecting element which reflects light emitted from the light emitting element; and
a light guiding element which has a plate-like shape which transmits light and which is disposed in a position where a rear surface thereof becomes opposite to the light reflecting element and light reflected by the light reflecting element is shone on thereto; wherein
a space is provided between the rear surface of the light guiding element and the light reflecting element.

2. The scuff plate according to claim 1, wherein the space is formed into a tapered shape in which a distance between the rear surface of the light guiding element and the light reflecting element becomes shorter as the space extends from one end portion to the other end portion of the light guiding element.

3. The scuff plate according to claim 1, wherein a rib which projects towards a direction of the light reflecting element is formed on the rear surface of the light guiding element in the vicinity of the one end portion thereof.
